(19) United States
(12) Patent Application Publication
(10) Pub. No.: US 2020/0230011 A1
(43) Pub. Date: Jul. 23, 2020

(54) Novel Birth Support

(71) Applicant: Birthsparks LTD, Ayrshire (GB)

(72) Inventor: Kathleen Marie McNamara, Ayrshire Central Scotland (GB)

(21) Appl. No.: 16/692,003

(22) Filed: Nov. 22, 2019

Related U.S. Application Data
(63) Continuation of application No. 15/100,996, filed on Jun. 2, 2016, now abandoned.

(30) Foreign Application Priority Data
Dec. 4, 2013 (GB) 1321348.3

(51) Int. Cl. A61G 15/00; A61G 13/00; A61G 15/10

(52) U.S. Cl. CPC A61G 15/005; A61G 13/0009; A61G 15/002; A61G 2200/38; A61G 2200/12; A61G 2200/34; A61G 15/10

(57) ABSTRACT

Provided herein is a novel birth support suitable for use throughout the three stages of labor and delivery. In particular there is provided a substantially U-shaped birth support including a plurality of U-shaped layers.

### CROSS REFERENCE TO RELATED APPLICATIONS

This application is a continuation of U.S. Ser. No. 15/100,996, filed Jun. 2, 2016, which is a National Stage application of International Application No. PCT/GB2014/053611, filed Dec. 4, 2014. This application also claims priority under 35 U.S.C. § 119 to Great Britain Application No. 1321348.3, filed Dec. 4, 2013.

### FIELD OF THE INVENTION

The present invention provides a novel birth support suitable for use throughout the three stages of labor and delivery. In particular the present invention provides a substantially U-shaped birth support comprising a plurality of U-shaped layers.

### BACKGROUND

Pregnancy and the anticipation of new motherhood are for many women the most looked-forward to times of their lives. However, the act of childbirth itself, particularly in societies where mothers typically give birth in hospitals, such as the UK, can for some women prove to be a disempowering experience, and at worst a frightening one. Such negative experiences can flow from a multitude of reasons, such as long and painful labors, uncomfortable or unsuitable positioning of the mother during labor and of course the potential of trauma for mother and/or child, where for clinical reasons emergency surgery becomes necessary.

Although, the long-standing conclusions from the House of Commons Health Committee, Second Report on the Maternity Services (Winterton report), London: HMSO; 1992, that “there is no convincing or compelling evidence that hospitals give a better guarantee of the safety of the majority of mothers and babies”, the number of home births in the UK has remained reasonably static over the past decade, with 2.5% of home births reported in 2013. However, at the same time there has been an increase in the numbers of women seeking more natural birthing methods suitable for use at home or hospital. With the continued growth of pre-natal counseling organisations such as the Natural Childbirth Trust, and an ever-increasing number of hospitals providing independent birthing units provided with dedicated equipment to assist in such births, has created a need for dedicated equipment to support and assist expectant mothers to give birth more naturally.

Care measures for labor and birth are judged according to how well they meet the following criteria: promotion of the mother's well-being; promotion of the baby's well-being and the facilitation of labor progress. Ideal care measures meet all three criteria at once. Research carried out by the World Health Organisation, (WHO) recommended that to meet these critical care measures, mothers should remain in an upright position for birth as it has been established that when a woman in labor is in an upright position, blood flow to the uterus is increased so she not only feels less pain, but also more oxygen is provided to the baby resulting in less foetal heart rate abnormalities.

Specialist birthing units are typically provided with a variety of birthing equipment which expectant mothers can choose to use according to the stage of their labor, such as birthing balls, birthing pools, birthing couches, birthing stools, cushions and beanbags.

Birthing balls are essentially physiotherapy balls that have been widely used for the relief of discomfort whilst sitting during pregnancy and, are now increasingly utilized as aids during the early stages of labor. However, due to their inherent design they can only be used during labor and not for giving birth. This means the mother has to move to another position or place to deliver her baby.

Birthing pools can be used throughout the labor and delivery process, although many women do choose to leave the pool for the actual delivery itself. Furthermore, it is known that the utility of birthing pools is limited to women who are medically able to use them: Barbara Harper, “Guidelines for a Safe Water Birth”, Waterbirth International, 2006; Garland and Crook, “Is the use of water in labor an option for women following a previous LSCS?”, MIDRS, Midwifery digest, 14:1, 2004, pp 63-67. As such, women with one or more of: limited mobility; raised BMI; a current or prior diagnosis of opiate analgesia; a previous sectional delivery; a pre-existing medical condition such as Type 1 diabetes, epilepsy, a blood born infection (BBI) such as Hepatitis C, HIV; women who may require further analgesia such as for example, an epidural; twins; breech; women who require continuous monitoring; women having a raised temperature; anyone who is overdue (over 42 weeks); women having a raised pulse or blood pressure; women with prior, previous complications during delivery such as a 3^{rd}/4^{th} degree tear; women predicted to have large, or small babies; women in premature labor; women with reduced foetal movements; women with a history of PPH in previous birth; women who have ruptured membranes for more than 24 hours; women where labor was induced via certain medications for example Prostin-induction, is suitable for a birthing pool delivery, whereas Syntocinon-induced labor is not. Other life-style related factors may exclude birthing pool use, such as for example women who smoke.

As indicated hereinbefore, for a range of reasons a woman may need to leave the pool during labor, such as for example: changes in the baby's heart rate; meconium or blood in the water; increases in her temperature, pulse or blood pressure; if additional pain relief, other than Entonox is required, or indeed simply for comfort reasons. For this reason, the use of a birth pool is limited to a select number of women who would want a water birth. For many women particularly those with mobility issues a birthing pool is unlikely to be a satisfactory option. Birthing couches, although less commonly used, are intended to provide a comfortable upright position. In essence these “mimic” the actual experience of many women during home births where couches or sofas are used to provide comfort and/or support during labor they are however large pieces of furniture that are not portable nor are they adjustable to suit the individual needs of each mother-to-be. Specialist cushions and beanbags are also used for the provision of some comfort during labor, again based on the “home-experience”.

Rigid wooden birthing stools have been traditionally used in many cultures for centuries, and are particularly useful for assisting women to give birth in a semi-squat position. Whilst the use of more modern alternatives made from hard plastics is increasing in birthing units, many mothers complain that their rigidity means they are uncomfortable for use during their labor. Furthermore, the rigid nature of conventional birthing stools can inhibit normal circulation which leads to an increased risk of perineal oedema and tears with resultant increased levels of blood loss for the mother for this reason it is recommended by health care professionals that they are only used for short periods during the second stage of labor. Thus there is a need for a natural birth support for use during labor which obviates the risk of perineal oedema and trauma associated with currently available birthing stools.

Whilst these positive developments are welcomed the Applicant has recognised that there is no single piece of equipment available to assist in natural births, whether at home, or in hospitals which is capable of providing the full range of support needed by an expectant mother from the first moment of contraction through to the delivery of her child and ultimately the placenta. Thus there is a need for a natural birth support for use during the three stages of labor and delivery.

The Applicant has also recognised that although women are increasingly encouraged to choose positions for labor and birth which suit their particular needs, in other words a movement towards a more tailored birthing experience, the fact remains that all birthing equipment is based on the “one size fits all” principle. This means that many women utilise more than one piece of equipment and also that for some women nothing can provide the degree of support they require for the maintenance a comfortable and upright position. Thus there is a particular need for a natural birth support for use during the three stages of labor and delivery which can be adapted to meet the needs of the individual mother-to-be, and ideally provide degrees of supporting flexibility throughout these processes even for women with other complicating factors.

It is an object of the present invention to provide a birth support for use throughout the three stages of labor which: is adapted to maintain the mother in an upright position for birth: including kneeling, squatting, all fours and sitting positions which can be adapted during the labor process; is suitable for use at home or in hospital; suitable for use during natural and drug-assisted labors; can be used to provide effective support during water births; is simple to use; is portable; requires no specialist knowledge or training for the expectant mother to use; can be used on the floor or the bed; can be used when the mother requires continuous monitoring; can be used when the mother has had or is to have an epidural; can be used by all of the mothers as defined hereinbefore, whom are excluded from a water birth, with the exception of those with a previous 3^{rd}/4^{th} degree tear. Furthermore, it is a yet further object to provide a birth support which can be used throughout the three stages of labor and for delivery and which will not impede any emergency procedures that could become necessary.

The Applicant has recognised that for mothers-to-be in resource poor settings, there is an increased motivation for healthcare providers, midwives and other professionals to maximise the number of women who are able to give birth without medical intervention. Examples of resource poor settings are mobile units, temporary units or other such units providing maternity care for women in remote areas. These could be for example units in countries that have a lack of emergency facilities, as is relatively common in many countries across the 3^{rd} and developing worlds. In such cases the availability of emergency back-up to perform medical procedures which are relatively safe in the Western world, is likely to either be unavailable. As such resource poor settings have high rates of obstructed or prolonged labors that can contribute to very high maternal and neonatal mortality rates. The Applicant has also recognised that providing a birth support which would encourage optimal, upright positions for birth is particularly important in resource poor settings because such optimal, upright positions increase the chance of a normal birth and decreases the chance of an obstructed or prolonged labor where medical interventions may be required. Thus there is a need for a safe, durable, and portable birth support which encourages use of optimal, upright positions for birth and which is capable of providing the full range of support needed by an expectant mother from the first moment of contraction through to the delivery of her child and ultimately the placenta.

In addition, even if emergency back-up/medical interventions are potentially available, in some settings where there is an associated risk of blood-borne infection there remains a need for a safe, durable, portable and easy to clean birth support which encourages use of optimal, upright positions for birth and provides mothers-to-be in settings where there is a risk of blood borne infections with the full range of support needed by an expectant mother from the first moment of contraction through to the delivery of her child and ultimately the placenta.

It is an object of the intention to provide a birth support suitable for use by mothers-to-be in resource poor settings. It is a particular object to provide a birth support which is provided in a form which is light-weight, portable, easy-to-inflate, easy-to-clean and cost effective. According to a further object the invention provides a portable birth support which is robust, is easily transported, and is suitable for use by aid agencies, medical professionals and midwives that provide services to women in countries that have a lack of emergency facilities.

It is a further object of the present invention to provide a birth support for use throughout the three stages of labor which effectively meet the WHO criteria for promotion of the mother's well-being, promotion of the baby's well-being and facilitation of labor progress.

The Applicant has now developed a novel birth support which provides versatile support options for use throughout the 3 stages of labor and delivery whilst maintaining the woman in an upright position for birth, and which is suitable for use at home or in hospital and can be used during natural and drug-assisted labors.

### SUMMARY OF INVENTION

The Applicant has developed a novel substantially U-shaped birth support comprising a series of inter-related inflation chambers provided by a plurality of U-shaped layers wherein each layer comprises a correspondingly substantially U-shaped tubular curvilinear hollow chamber, wherein said layers are located one upon another, wherein each of the layers is connectedly attached to at least one further layer, and wherein one or more of the chambers may be independently inflated and/or deflated. According to at least one further aspect the present invention provides a substantially U-shaped birth support comprising a plurality of tubular layers as defined above.

According to at least one further aspect the present invention provides a substantially U-shaped birth support comprising a plurality of tubular layers as defined above wherein the base layer of the birth support incorporates stabilizing means.

According to at least one further aspect the present invention provides a substantially U-shaped birth support comprising a plurality of tubular layers as defined above wherein one or more suction cups are located on the underside of the base layer of the birth support.

According to one further aspect the present invention provides a substantially U-shaped birth support comprising a plurality of U-shaped layers, and in particular two U-shaped layers, as defined above wherein one of said layers additionally comprises integral handles.

According to one further aspect the present invention provides a substantially U-shaped birth support comprising a plurality of U-shaped layers, as defined above wherein the integral handles are located upon the uppermost layer of the birth support and the suction cups are located on the underside of the base layer of the birth support.

According to one further aspect the present invention provides a substantially U-shaped birth support comprising a plurality of U-shaped layers, and in particular two U-shaped layers, as defined above wherein the integral handles are located upon the uppermost layer of the birth support, and wherein the suction cups are located on the underside of the base layer of the birth support.

According to a further aspect the present invention provides a substantially U-shaped birth support comprising a plurality of U-shaped layers, and in particular two U-shaped layers, as defined above wherein the base layer comprises a hollow chamber having at least one valve suitable for gaseous inflation/deflation, and at least one valve suitable for liquid filling/emptying.

According to an aspect the present invention provides a novel substantially U-shaped birth support or birth seat comprising a plurality of U-shaped layers wherein each layer comprises a correspondingly substantially U-shaped tubular curvilinear hollow chamber, wherein said layers are stacked one upon another, wherein each of the so-stacked layers is connectedly attached to at least one further layer, and wherein one or more of the chambers may be independently inflated and/or deflated.

For the avoidance of doubt, the particular features of each of the so-specified aspects as defined hereinbefore, may be combined with one another to provide additional aspects, and each of these further, co-combined, additional aspects are considered to be yet further aspects within the scope of the present invention.

### DETAILED DESCRIPTION

As discussed hereinbefore, there is no single piece of equipment available to assist in vaginal births, whether at home or in hospitals which is capable of providing the full range of support needed by an expectant mother from the first moment of contraction through to the delivery of her child-regardless of medical complications.

There is currently no birth support suitable for use in natural or drug-assisted, hospital or home vaginal-births, which can be used throughout the three stages of labor and for delivery and effectively meets the WHO criteria for promotion of the mother's well-being, promotion of the baby's well-being and facilitation of the labor progress.

The Applicant has developed a novel soft substantially U-shaped inflatable birth support, that provides effective and comfortable support for the mother-to-be, and which particularly allows her to maintain the optimal position for giving birth by maximizing the available space in her pelvis. Uniquely the novel birth support of the present invention is suitable for use by any woman planning a vaginal birth. This is of particular benefit for women who have had to have an epidural, with resultant loss of use of her legs.

Currently women having epidurals typically give birth lying on their backs. This is the least beneficial physiological position from which to birth a baby and the incidence rate of instrumental or caesarean delivery in this group is high. Advantageously the novel birth support of the present invention can be used by women post-epidural injection.

Advantageously the novel birth support is multi-functional and can be used to provide support to a mother-to-be whilst in a seated position, as well as providing support whilst a mother-to-be is in a kneeling position, or on all fours during the three stages of labor and birth, and additionally can be used to provide support for the mother-to-be whilst in any resting position. This multiple-functionality is unprecedented in the area of birthing equipment where to date there has been no single support which can provide the necessary levels of support throughout the entire birthing process. FIGS. 1, 2, 3 and 4 illustrate various aspects of the multiple functionality provided by the novel birth seat when used during different stages of labor and birth.

Substantially U-shaped as defined herein means a curved, bent, rounded, arched or similar curvilinear shape which is a U-shaped curve that is bounded, formed or characterized by curved lines. Examples of substantially U-shaped suitable for use herein include horseshoe or magnet-shaped inflatable birth supports wherein the internal space within the U can accommodate a mother-to-be giving birth whilst in a seated or squatting position and facing outwards from the birth support, and can accommodate her pregnant abdomen if the mother-to-be is on all fours and is facing forwards into the birth support.

FIGS. 5, 6, 7 and 10 illustrate features of a particular embodiment of the present invention comprising a plurality of layers wherein each layer comprises a correspondingly substantially U-shaped curvilinear chamber, and wherein the uppermost layer additionally comprises two integral handles, and the underside of the base layer is provided with stabilizing means comprising four suction cups. FIGS. 8 and 9 provide illustrations of a single handle and suction cup. FIG. 14 provides various illustrations of a further particular birth support which is an embodiment of the present invention.

The term “birth support” as defined herein includes birth support, childbirth support, child delivery support, and support for use during labor. As will be readily appreciated by the skilled professional, and as discussed hereinbefore whilst the novel birth support can provide support to a mother-to-be whilst in a seated position, the position which the birth support enables her to adopt is not a conventional “sitting position” with legs forward or akimbo as would be provided by a typical seat such, but rather a position where both her rear and legs can be supported, as illustrated in FIG. 1.

The particular features of the novel birth support, including the shallow nature of the internal U is especially advantageous for the provision of support whilst a mother-to-be is in a kneeling position or on all fours during the three stages of labor and birth, as illustrated in FIG. 2.

Additionally, the particular features of the novel birth support, including the extended width of the rear section of the birth support is especially advantageous for the provision of support and stability for the mother-to-be whilst she is kneeling and pushing down onto the support with her hands as illustrated in FIG. 3.

During extended labors which can be physically exhausting and mentally taxing for a mother-to-be the flexible nature of the novel birth support, particularly the adjustable height of the chambers is advantageous for the provision of fit-for-purpose resting position for the mother-to-be, whilst providing a safe space for her bump, as illustrated in FIG. 4.

As detailed herein the novel substantially U-shaped birth support comprises a plurality of U-shaped layers wherein each layer comprises a correspondingly substantially U-shaped curvilinear hollow chamber, wherein each chamber may be independently inflated and/or deflated, wherein said layers are located one upon another, wherein each of the layers is connectedly attached to at least one further layer. Each hollow chamber, or layer, or compartment comprises a flat base portion, a flat upper portion and side portions which may be flat or curved. The outward curved nature of particular embodiments of inflated birth supports are clearly illustrated in the Figures.

As detailed hereinafter the manner by which the birth supports in accordance with the present invention are preferably manufactured provides a plurality of U-shaped layers, chambers or compartments each of which can be separately inflated/deflated, and preferably wherein each chamber, layer or compartment additionally comprises one or more supportive internal ribs.

Whilst the base and upper portions of the individual layers are correspondingly substantially U-shaped, the birth support may comprise layers having curved, or straight side portions or mixtures thereof, and wherein the terminal ends of said side portions are curved in shape. Thus the individual substantially U-shaped layers may be formed from cylinders, or from shapes having the characteristics of a cylinder, or from flattened cylinders, or from one or more substantially U-shaped patterns which when moulded together with one or more corresponding side portions or a surrounding wrapper, provide a birth support as defined herein. A cylinder as defined herein means a curvilinear geometric shape whose surfaces are formed by points at a fixed distance from a specific line segment.

As described hereinbefore the Applicant has found that where the plurality of U-shaped layers are deeper, or thicker, or wider at the central portion of the U-shape versus the relative length of the narrower terminal portions, this provides a birth support having a shallow internal U-shape having enhanced stability. In addition the Applicant has also found that novel birth supports having a shallow internal U-shape have enhanced stability, and provide additional support and comfort to the user, all of which are important factors in providing enhanced safety for the mother. For the avoidance of doubt, and as illustrated by the internal space (Y) in FIG. 10(a) the internal shallow U-shape is defined by the internal edges of the U-shaped layers of the birth support. The Applicant has found that birth seats having a shallow U shape provided via a ratio of the central portion depth of the U-shaped layer to the terminal portion length of the U-shaped layer of from about 2:1 to about 1.2:1, and particularly a ratio of about 4:3 are particularly stable. Whilst various embodiments of the novel birth sear having a shallow U shape as defined herein are illustrated in the Figures, as will be reasonably appreciated, any depth to length arrangement which provides a safe and stable birth support in accordance with the present invention is considered to be within the present scope.

Thus, according to a yet further aspect the present invention provides a novel birth support as defined hereinbefore wherein the relative depth of the central portion versus the terminal end portions is from about 2:1 to 1.2:1, and particularly a ratio of about 4:3.

This internal open-U-shaped space between the terminal ends of the U-shaped birth support allow the mother-to-be to reverse onto and squat down upon the support or additionally to kneel on the floorwhile leaning over to use the rear of the birth support to provide support for her upper body, or to kneel on the floor whilst facing upwards to use the rear or sides of the birth support to provide support for her hands, or forearms.

The distance between these terminal ends should be sufficiently wide to enable easy visualisation of the maternal perineum by care providers and safe and comfortable access during labor if necessary.

A relative width ratio of from about 1:5 to about 1:3; about 1:4; about 1.3:6 between the internal end-to-end width and the centre-to-entry point has been found to be particularly beneficial for both comfortable use and provision of effective support levels.

The birth supports illustrated in the Figures hereinafter have a central: terminal depth to width ratio of 4:3 and a terminal end to central access ratio of 1.3:6. Alternative terms within the definition of substantially U-shaped which can be used to describe the birth supports herein, and in particular those illustrated herein are “cocoon-like”, magnet-shaped and or Horse Shoe shaped.

The Applicant has additionally found that enhanced in-use stability and shape-integrity is provided by the utility of one or more supportive ribs inside one or more of the layers of the birth support. The term supporting rib as defined herein means a reinforcing panel section. Thus the present invention additionally provides a novel substantially U-shaped birth support comprising a plurality of U-shaped layers wherein each layer comprises a correspondingly substantially U-shaped tubular curvilinear hollow chamber having one or more internal ribs, wherein said layers are located one upon another, wherein each of the layers is connectedly attached to at least one further layer, and wherein one or more chambers may be independently inflated and/or deflated.

Advantageously said ribs may be located in the same positions in each of the plurality of layers in the birth support for the delivery of additional stability, as well as maintaining ability to support the mother in the desired position during use. To enable effective inflation and deflation and to allow for internal air flow in use, such as for example when a mother who is using the seat shifts her position, said ribs are located within one or more of the chambers, but do not split any chamber up internally. Any suitable number of internal ribs may be employed to provide the desired levels of stability. According to a further aspect each chamber may comprise: between two and five rubs; between three and five ribs; four ribs. The ribs may be manufactured from any suitable material having the necessary strength to provide the desired level of stability and the necessary flexibility to enable the birth support to be used effectively.

Thus the present invention additionally provides a birth support according to the present invention having two chambers as defined herein, each with four internal ribs, and wherein each chamber has an inflation/deflation value, wherein the upper chamber has two external handles, wherein stabilizing means is provided on the underside of the base layer, and wherein the locations of the ribs in each chamber are substantially the same. An example of such a birth support is provided in FIG. 11 wherein the birth support layers are provided via welding the external edges or seams of a series of panels of flexible material comprising: a top panel; one or more internal panels; and a base panel onto a flexible wrapper, and wherein a series of ribs aligned in parallel with each other are welded to the underside of the top panel and the one or more internal panels, and wherein the ribs comprise: a pair of long ribs each one of which extends into one of the terminal sections of each layer; and a pair of corresponding short ribs each one of which extends from the a point towards the rear of the seat-like portion of the birth support to a point towards the front portion of the birth support. To construct the birth support the downward extending ribs from the top (or seat-like) panel are welded to the top-face of an internal panel, and this process repeated until the downward extending ribs of the final internal panel are welded to the top-face of the base panel of the birth support.

Thus the present invention additionally provides a method for the manufacture of a birth support comprising:

(i) welding a first series of ribs aligned in parallel with each other to the underside of a U-shaped top panel;

(ii) further welding the series of ribs from (ii) to the top-side of a first internal U-shaped panel;

(iii) welding a second series of ribs aligned in parallel with each other to the underside of the first internal panel of (iii);

(iv) optionally repeating steps (ii) and (iii) with one or more further U-shaped internal panels;

(v) further welding the second series of ribs from (iii) to the top-side of a U-shaped base panel

(vi) welding together the external edges or seams of a series of panels of flexible material comprising: a top panel; one or more internal panels; and a base panel onto an external flexible wrapper wherein the ribs comprise: a pair of long ribs each one of which extends into one of the terminal sections of each U-shaped layer; and a pair of corresponding short ribs each one of which extends from the a point towards the rear of the U-shaped portion of the birth support to a point towards the front portion of the birth support.

As will be appreciated this method can be used to prepare birth supports having three or more layers by inclusion of additional internal panels and additional series of ribs.

According to a yet further aspect the present invention provides a birth support substantially as described herein and in accordance with any of FIGS. 1 to 11.

The multiple supportive arrangements provided by the novel birth support according to the present invention facilitate it's suitability for use by any mother-to-be during labor regardless of her height or relative level of mobility.

Currently none of the birthing aids available are capable of adjustment should mobility be restricted during labor, such as for example during the use of epidural analgesia, infusion pumps or electronic foetal monitoring. Uniquely and advantageously, the novel birth support according to the present invention can be easily adjusted to a safe height for use on a hospital bed. Flexibility of support levels can be delivered by adjusting the air-fill levels within one or more selected layers of the birth support.

Advantageously these unique features ensure that the novel and inventive birth support of the invention maintains all of the important benefits for the mother of remaining upright even when complicating factors need to be considered. In addition the support provided by the layered structure of the seat allows the mother-to-be to completely relax between contractions allowing her to rest when she needs to.

Advantageously, and as discussed in more detail hereinafter the novel birth support provides safe, stable and secure support which is ready to use device once inflated. The Applicant has found that the unique shallow U-shaped internal aspect of the novel birth support is particularly useful for the provision of a safe, secure and stable birth support even where only one of the U-shaped layer one of the U-shaped layers is inflated, or where the base (or bottom) later is inflated and the remaining one or more layers are only partially inflated.

The Applicant has recognised that to provide optimal support during labor and particularly whilst giving birth it is important for a mother-to-be to have her posterior at a lower level than her knees, and especially for the angle between the base of her spine and the top of her knees, whilst in this backward leaning, legs-apart, semi-squatting position, is advantageously at about 180 in order to provide maximum space in the pelvis. As clearly illustrated in FIGS. 12(a) and 12(b) hereinafter the use of birth supports in accordance with the present invention encourages mothers-to-be to adopt this position. For the avoidance of doubt, whilst FIGS. 12(a) and (b) indicate the angle between the rear and shins to be about 12°, the corresponding angle between the rear and knees has been determined to be about 18°.

Thus in accordance with a further aspect the invention additionally provides a birth support as defined herein adapted to encourage use of an ergonomically optimal birthing position wherein the angle between the base of the spine and the top of the knees of the user is in the region of from about 12° to about 22°, and is particularly from about 15° to about 20°, and especially about 18°.

The novel birth support is a stand-alone device which does not require attachment or securement to the surface on which it is to be used. The stability of the novel birth support during use is provided a combination of features including: the substantially U-shaped layers; the shallow-U shape; the relative ratio of the width of the U-shape to the length of the U-shape; the relative ratio of the height of the one or more substantially U-shaped layers to the length of the one or more layers. The ability to provide security, safety and stability in a multi-functional stand-alone device which itself can be moved around to other areas of the birthing environment is unique in this field.

The novel birth support is suitable for use in a variety of situations including use on the floor, including use at home, in a hospital or in a specialist birthing unit, or use on a raised surface such as a bed, or use in a pool.

As indicated previously herein the birth supports are lightweight, portable, durable, easy-to-inflate and easy-to-clean. Exemplary birth supports are detailed hereinafter, particularly the birth support illustrated in FIG. 14, and as described in the Results hereinafter, and birth supports have been made from 0.500 biocompatible PVC and in un-inflated form weigh about 2 Kg and once packed have a similar volume to a ream of A4 paper or a small lap-top case. Thus the invention provides portable, lightweight birth supports.

Whilst, as stated herein the novel birth support is a stand-alone device which does not require additional means to provide a safe and secure birthing experience, there may be occasions where, for additional peace-of-mind to a mother-to-be further stabilizing means for the base layer of the birth support can be provided. For example, if a mother-to-be is concerned that her weight may be an issue, or if a waterbirth is planned, then the novel birth support may include additional stabilizing means on the underside of the base layer.

Additional stabilizing means for the base, or bottom layer as defined herein means any suitable measure or combination or measures to effectively maintain the birth support in the desired locations during use. Stabilizing means may comprise a solid, or “filled” base layer where stability is provided by the weight of the contents within the base layer. Stabilizing means may comprise a base layer upon the underside of which are located one or more features which are adapted to provide yet further fixed-in-place stability measures for the birth support. As such, stabilizing means as defined herein includes: one or more feet; one or more fixing and stabilizing means such as suckers, or suction cups. One or more suction cups can be welded onto the underside of the base of the birth support to provide an effective attachment point onto the bottom of a birth pool to stop the birth support floating, or from sliding when put onto a smooth and/or highly polished floor surface.

The present invention additionally provides as a yet further aspect a novel and inventive suction cup suitable for use in the birth supports herein. Use of one or more of such suction cups provides both stabilizing means to securely locate the birth support into the desired position, but additionally means to fixedly attach the birth support to the surface for use, for example flooring or base of a birth pool if desired. FIG. 9 provides a series of illustrations relating to a single suction cup, for use on a birth support in accordance with the present invention. For the avoidance of doubt a number of such cups may be utilized, as illustrated in FIGS. 6 and 7, on either the underside of base layer or on the outermost edge of the base layer of a birth support in accordance with the present invention in order to provide stability and fixation.

Thus the present invention additionally provides a substantially U-shaped birth support comprising a plurality of U-shaped layers wherein each layer comprises a correspondingly substantially U-shaped tubular curvilinear hollow chamber, wherein said layers are located one upon another, wherein each of the layers is connectedly attached to at least one further layer, wherein one or more chambers may be independently inflated and/or deflated, and wherein said base layer includes one or more suction cups wherein each cup comprises:
(a) an outermost portion comprising a weldable disc;
(b) an upper portion surrounded by said weldable disc;
(c) a base portion; and
(d) a central section comprising a central hole, and one or more additional holes, wherein said additional holes are provided to enable air trespass.

Thus the present invention additionally provides a novel and inventive weldable suction cup comprising:
(a) an outermost portion comprising a weldable disc;
(b) an upper portion surrounded by said weldable disc;
(c) a base portion; and
(d) a central section comprising a central hole, and one or more additional holes, wherein said additional holes are provided to enable air trespass.

According to a yet further aspect the present invention additionally provides a novel and inventive suction cup comprising:
(a) an upper portion;
(b) a base portion; and
(c) a central section comprising a central hole, and one or more additional holes, wherein said additional holes are provided to enable air trespass.

Thus the present invention additionally provides a substantially U-shaped birth support comprising a plurality of U-shaped layers wherein each layer comprises a correspondingly substantially U-shaped tubular curvilinear hollow chamber, wherein said layers are located one upon another, wherein each of the layers is connectedly attached to at least one further layer, wherein one or more chambers may be independently inflated and/or deflated, and wherein said base layer includes one or more suction cups wherein each cup comprises:
(a) an upper portion;
(b) a base portion; and
(c) a central section comprising a central hole, and one or more additional holes, wherein said additional holes are provided to enable air trespass.

A particular advantage associated with the use of a birth support of the invention which comprises stabilizing means comprising one or more suction cups as defined herein is that the cups enable effective positioning and thereafter positive fixation of the birth support onto the flooring where the birth support is to be used, such as in a maternity ward or birthing suite, or onto the base of a birthing pool.

In one aspect the birth support may be utilized with the base layer being water-filled to provide stabilizing means giving enhanced stability, for example where a woman wishes to utilize the birth support in a birthing pool, or move around and/or within the birth support on the floor during an especially “active” labor and birthing process. Flexibility of support levels can be delivered by adjusting the air-fill levels within the individual upper layer(s), where a water-filled base layer is used in the birth support, or selected layers, or all layers, where an all-air filled version is used, such as for example on top of a hospital bed.

Thus according to a yet further aspect the present invention provides a novel birth support as defined hereinbefore wherein the base layer includes a valve suitable for water filling. This additional water fill valve allows the bottom chamber of the seat to be filled with water which will weight it sufficiently to enable the seat to sink into a birth pool, for use during water births.

The birth support may be constructed from any suitable flexible material which can be inflated, has sufficient strength when inflated to support a mother during the labor and birthing process, and is water resistant. For the avoidance of doubt the layers, and handle, or handles, where present, may all be constructed from a common flexible material. Alternatively, where for example different strength and/or load bearing characteristics are desirable for the handle or handles, and one or more of the layers of the birth support, then the handle, or handles and such one or more layers may be constructed from different flexible materials. In addition to their advantages for use by women during labor and birthing, the novel birth supports are lightweight, portable, re-usable, easy-to-clean and require no specialist knowledge to use.

Suitable flexible materials for use herein include: polymeric plastic materials such as eco-friendly, non-toxic, polyvinylchloride (PVC), Poly Eurothane (PU), polymer environmentally friendly resin (PER); bio-composited made by reinforcing bio-material polymers such as soy-based bio-polymers with environmentally friendly fibers such as kenaf and jute; and/or keratin-based plastics.

Clearly the thickness of the flexible construction materials will contribute to the strength and durability of both the individual layers and the birth support as a whole. Flexible materials having a thickness of from about 0.2 mm to about 0.8 mm, from about 0.3 mm to about 0.7 mm, from about 0.4 mm to about 0.6 mm are particularly suited for use herein.

An additional benefit of the birth supports of the present invention is that by selection of an appropriate flexible material of appropriate thickness the seats can support a wide weight range. For example, birth supports in accordance with the present invention have been pressure-tested to support weights up to 200 kg.

According to a further aspect the birth supports are constructed from strong durable flexible materials which have been demonstrated to be durable and abrasion resistant when used in inflatable products.

This aspect is particularly important for birth supports for use in birthing centres or hospitals, or by use by doulas, where the seats are more likely to be used, and re-used again and again.

In plastic processing typically additives are used to provide enhanced properties, however some of these additives, for example phthalates such as diethylhexylphthalate (DEHP) and diisononylphthalate (DINP which are used as plasticizers are toxins. Preferred for use in the birth supports herein are: latex-free materials; formaldehyde free materials; phthalate free materials; cadmium free materials; BPA free materials; heavy metal free; lead free.

The birth supports will be in close contact with both mother and potentially baby care should be taken to ensure the seats are constructed from materials consistent for use in a pre- and post-natal context.

Accordingly birth supports of the present invention are preferably: formaldehyde free; latex free; phthalate free materials; cadmium free; and/or are biocompatible.

The layers may be connectedly attached to one another during the construction process by any suitable means.

Any suitable inflation/deflation valve arrangement may be utilized in the birth supports according to the present invention. Valves such as those employed in physical therapy balls, or birthing pools may be effectively employed, as these have been demonstrated to be particularly suitable for use in birthing aids. The birth supports may be inflated and deflated by suitable activation of the selected valve arrangement, such as for example a Carmo 03-327 valve. Thus layers, chambers, compartments in the novel and inventive birth supports according to the present invention may be inflated via any suitable means which is consistent with the particular value arrangement employed, and includes: hand pumps, foot pumps, electric pumps and the like. In addition a suitable pump may be utilized to top up if necessary, for a water birth a hand pump should be used top up. According to a preferred aspect, the valves for use herein include suitable covers. According to another aspect the one or more valves on each layer, chamber or compartment of the birth support is an integral valve.

Integral handles may be located either as an elongated handle partially surrounding one or more layers of the birth support, or as pairs of handles at equivalent positions on the outer-edges of one or more layers of the birth support to facilitate leverage for the woman during active labor as well as to make transportation easier when the birth support is inflated. Alternative positions of such pairs of handles are illustrated in FIGS. 6 and 7 herein, and FIG. 8 illustrates further features of a handle suitable for use herein. The handle may be fashioned from any suitable flexible material, and prepared from a suitable pattern. To minimise potential bacterial contamination, the handle is preferably manufactured by welding the central portions of the pattern of flexible material together to form the central substantially tubular grip portion, with the corresponding tab portions of the patters being welded to the uppermost layer of the birth support. Preferably each of said tab portions is welded flat to the corresponding area of the uppermost later of the birth support. To ensure a secure-weld, the tab portions are welded flat at each end for: 5 mm; 8 mm; and ideally 10 mm. Prior to the final weld to seal the grip portion, the central grip portion may be advantageously filled with a suitable material to provide a comfortable hand-grip. Any suitable filling material such as for example foam may be used.

As illustrated in the Figures herein, it is preferred that the birth support has smooth curved edges, the advantage of this aspect is to allow the woman to move her pelvis, legs and feet easily. As will be appreciated, any suitable means may be used to provide a plurality of U-shaped layers wherein each layer comprises a correspondingly substantially U-shaped curvilinear hollow chamber and wherein the edges of such layers are smooth and curved, such as for example, selection of a suitable pattern and moulding to provide individual layers having smooth and curved edges which can be moulded or welded together to provide a birth support having a plurality of such layers. Without wishing to be bound to any particular theory it is proposed herein that this particularly facilitates her mobility, especially during an “active birth”, whilst at the same time ensuring that her sacrum and coccyx is unimpeded and thereby ensuring the maximum pelvic diameters for the baby's head to negotiate its way through the pelvis. It is this aspect of the upright position that research has shown to significantly reduce the length of the second stage of labor and reduce the incidence of foetal distress: Gupta et al., Position in the second state of labor for women without epidural anaesthesia”, The Cochrane Collaboration®, Published by John Wiley & Sons, Ltd, Issue 4, 2007.

As discussed herein the novel birth support of the present invention not only provides effective support to a mother throughout her labor, but also provides the hitherto impossible benefit of positively assisting a baby to be in, and stay in, the best (easiest) position for birth and also to enable the mother to optimise the available space in her pelvis throughout the birthing process which increases the potential for a faster, easier birth, and thereby safer birth.

This means more oxygen to the baby, more normal fetal heart patterns, more effective uterine contractions, a shorter second stage of labor, and less need of pain medications, all of which are positive factors that encourage a normal vaginal birth and reduce emergency intervention rates.

Whilst the present invention is illustrated and discussed in relation to the particular embodiments illustrated in the following Figures, it should be appreciated that variations as the relative depths of the individual layers, or alternative minor variations as to the relative proportions of the birth support features are within the scope of the present invention. As such, the following Figures are to be considered to be both representative and at the same time, non-limiting examples according to the present invention.

### BRIEF DESCRIPTION OF THE DRAWINGS

FIG. 1 illustrates a side view of a substantially U-shaped birth support (1) in inflated (filled form) when in use to provide support to a mother-to-be in an upright birthing position.

FIG. 2 illustrates a side view of a substantially U-shaped birth support (1) in inflated (filled form) when in use to provide support to a mother-to-be giving birth in a substantially kneeling position.

FIG. 3 illustrates a side view of a substantially U-shaped birth support (1) in inflated (filled form) when in use to provide support to a mother-to-be on all fours.

FIG. 4 illustrates a side view of a substantially U-shaped birth support (1) in inflated (filled form) when in use to provide support to a mother-to-be in an resting position.

FIG. 5 illustrates a top-side view of a substantially U-shaped birth support (1) in inflated (filled) form.

FIG. 6 illustrates an underside view of a substantially U-shaped birth support (1) in accordance with the birth support of FIG. 1.

FIG. 7(a) illustrates a top-view of an alternative substantially U-shaped birth supports (1) in inflated (filled) form.

FIG. 7(b) illustrates a perspective view of alternative substantially U-shaped birth supports (1) in inflated (filled) form.

FIG. 8(a) illustrates a top-side view of a single handle (4) having a central raised portion 4(a) and a pair of corresponding tab portions 4(b).

FIG. 8(b) illustrates a top view of the single handle (4) having a central grip section 4(c), and two raised portions 4(d) wherein the top-width of the handle taper outwards from each end of said central grip section to the corresponding tab portions 4(b).

FIG. 8(c) illustrates a side view of the single handle (4) having a central grip section 4(c), and two raised portions 4(d) wherein the sectional width of the handle tapers downwards from each end of said central grip section to the corresponding tab portions 4(b).

FIG. 8(d) illustrates an underside view of a single tab portion 4(b) and shows closure section 4(e) in use two of these closure sections are welded to the handle at each end, under the tab-portion, and then the two tab-portions are welded to the birth support to provide a single handle.

FIG. 9(a) illustrates a top view of a single weldable cup arrangement (7) having an outermost portion comprising a weldable disc 7(a) which is moulded as a single component to a suction cup.

FIG. 9(b) illustrates an underside figurative view of a single weldable cup arrangement (7) having a central section 7(d) comprising a central hole X, and one or more additional holes for air trespass, and in this case, four additional equi-spaced holes P, Q, R, S, and having a surrounding outer lip portion 7(c) which is terminated by circumferential external rim 7(e).

FIG. 9(c) illustrates a sectional view of the cup arrangement of FIG. 9(b) cut through section J to J. n underside figurative view of a single cup (7) having a central section 7(d) comprising a central hole X, and one or more additional holes for air trespass, and in this case, four additional equi-spaced holes P, Q, R, S, and having a surrounding outer lip portion 7(c) which is terminated by circumferential external rim 7(e).

FIG. 9(d) illustrates a side-view of a single weldable cup arrangement (7) having an outer weldable disc 7(a) moulded to a suction cup which may be cast or moulded from a suitable flexible material, wherein said suction cup comprises an upper, or top portion 7(b), a lower lip section 7(c), a central section 7(d) and a rim section 7(e) the circumference of which surrounds and is connected/welded to a further section 7(f).

FIG. 10(a) illustrates a top-view of the substantially U-shaped birth support (1) of FIG. 5.

FIG. 10(b) illustrates a front-facing view of the substantially U-shaped birth support (1) of FIG. 5.

FIG. 10(c) illustrates a side-view of the substantially U-shaped birth support (1) of FIG. 5.

FIG. 11 illustrates an expanded-view of a substantially U-shaped birth support (1).

FIGS. 12(a) and 12(b): Illustrates use of an alternative embodiment of a birth support (14) herein having three inflatable compartments by a model in two different ergonomically suitable postures for labor.

FIGS. 13(a), 13(b) and 13(c) illustrate the suitability of use of the alternative birth support (14) of FIG. 12, by a range of mothers-to-be of different heights.

FIGS. 14(a)-(d) illustrate an exemplary birth support (15) in accordance with the present invention.

FIG. 15 illustrates an alternative embodiment of a U-shaped birth support (16) in accordance with the invention.

### FIGURE DETAILS

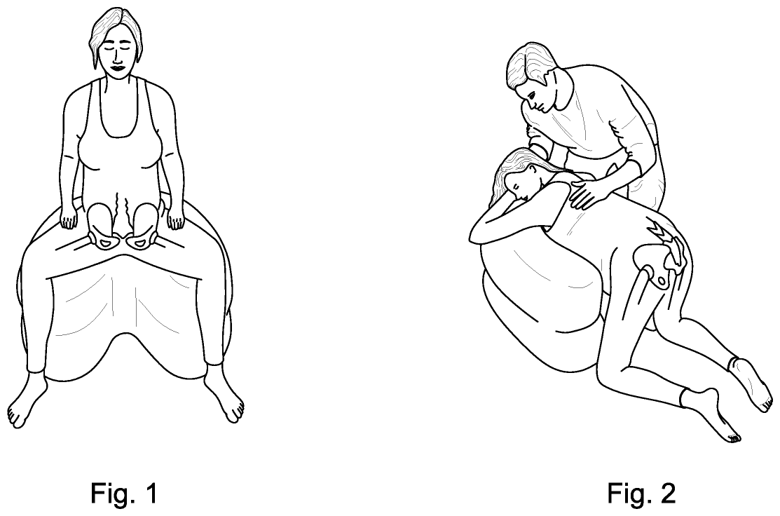

FIG. 1: illustrates a side view of a substantially U-shaped birth support (1) in inflated (filled form) when in use to provide support to a mother-to-be in an upright birthing position.

FIG. 2: illustrates a side view of a substantially U-shaped birth support (1) in inflated (filled form) when in use to provide support to a mother-to-be giving birth in a substantially kneeling position.

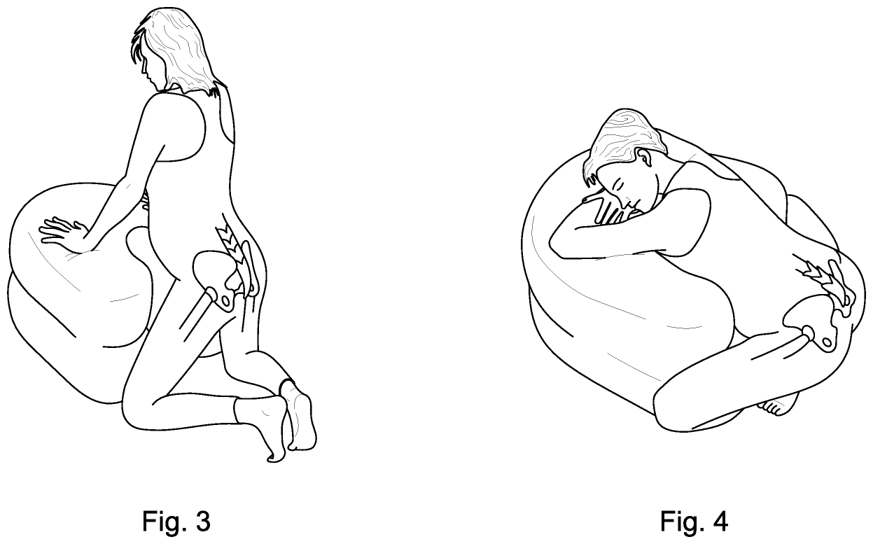

FIG. 3: illustrates a side view of a substantially U-shaped birth support (1) in inflated (filled form) when in use to provide support to a mother-to-be on all fours.

FIG. 4: illustrates a side view of a substantially U-shaped birth support (1) in inflated (filled form) when in use to provide support to a mother-to-be in an resting position.

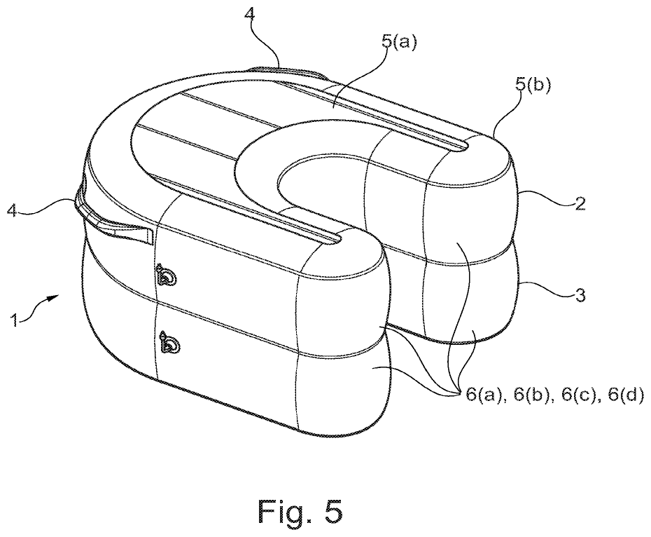

FIG. 5: Illustrates a top-side view of birth support (1) comprising 2 individual layers which comprise a substantially U-shaped uppermost chamber (2) and a substantially U-shaped base chamber (3), and wherein a pair of handles (4) are located at corresponding rear-side locations on the upper-edge of chamber (2), wherein the top of birth support (1) as provided by the upper-face of chamber (2), comprises a seat-like section (5)(a), and a substantially rounded surround (5)(b), and wherein the four terminal portions of chambers (2) and (3) comprise substantially rounded portions (6)(a),(b),(c) and (d);

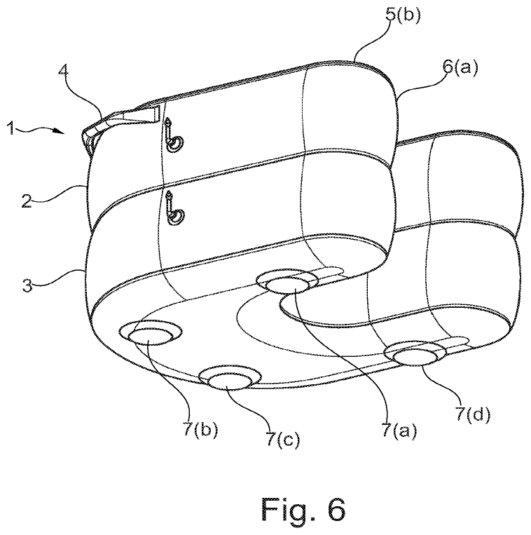

FIG. 6: Illustrates an underside view of a substantially U-shaped birth support (1) in accordance with the birth support of FIG. 1 wherein (1), (2), (3), (4), and (6) are as defined in FIG. 5, and wherein although not illustrated in this view, seat-like section (5)(a) is present, wherein base chamber (3) incorporates stabilizing means provided by suction cups (7)(a), (7)(b), (7)(c) and (7)(d) arranged on the underside of base chamber (3) to provide stabilization towards the rear-portion and the front-portions of base chamber (3);

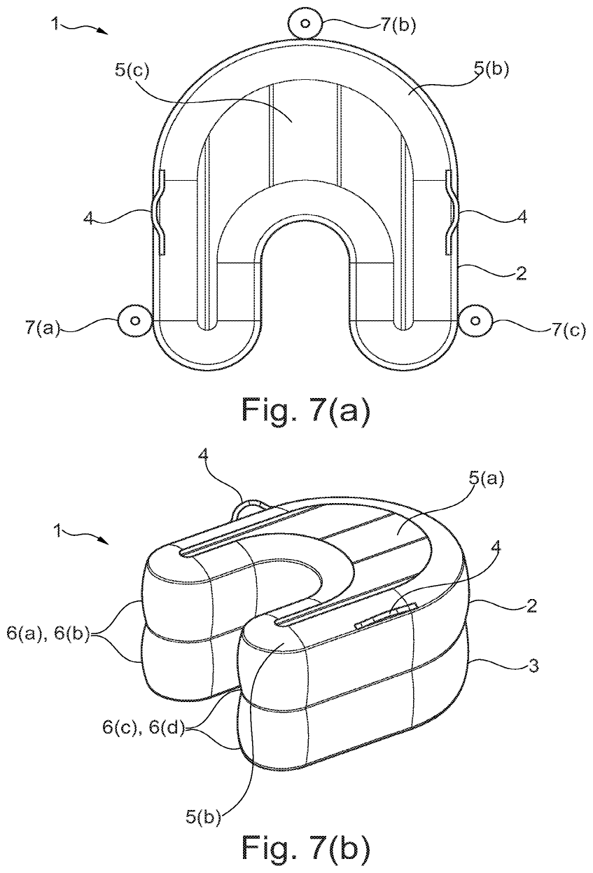

FIG. 7(a): Illustrates a top-view of an alternative handle and suction cup arrangement on a birth support (1) having a pair of handles (4) located at corresponding rear-side locations on the edge of the upper-face of a substantially U-shaped upper chamber (2) of birth support (1), wherein the top of birth support (1) as provided by the upper-face of chamber (2), comprises a seat-like section (5)(a), and a substantially rounded surround (5)(b), and wherein the base chamber (3) (not seen in this view) incorporates suitable stabilizing means arranged to provide stabilization at the rear and on each side of the lower or base chamber (3) of the birth support (not shown) wherein stabilizing means is provided by suction cups (7)(a), (7)(b) and (7)(c) attached to the external edge of the base chamber (3) and located to provide stabilization at the rear portion and the front-ends of base chamber (3); FIG. 7(b): Illustrates a perspective view of a birth support (1) having the alternative handle arrangement shown in FIG. 7(b) provided by a pair of handles (4) located at corresponding rear-side locations on the edge of the upper-face of substantially U-shaped upper chamber (2) of the birth support (1), wherein the top of birth support (1) as provided by the upper-face of chamber (2), comprises a seat-like section (5)(a), and a substantially rounded surround (5)(b), and wherein the base chamber (3) incorporates alternative stabilizing means (not shown) on the underside of the base chamber (3) wherein the stabilization is provided by suction cups (7)(a), (7)(b), 7(c) and (7)(d) attached to the underside of the base chamber (3) and located to provide stabilization at the rear and front-ends of base chamber (3);

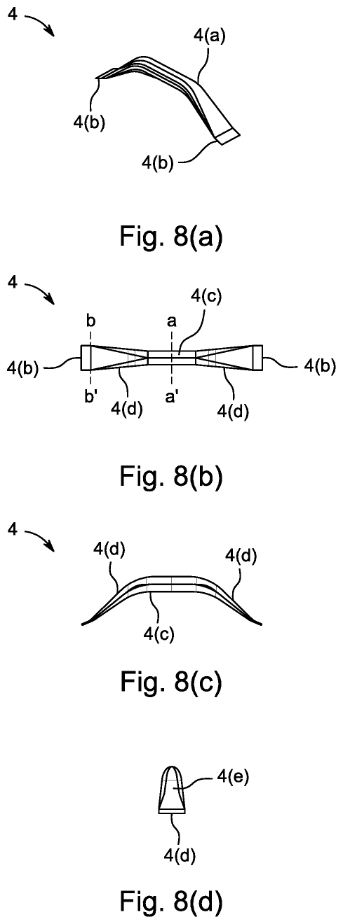

FIGS. 8(a), 8(b), 8(c), 8(d) and 8(e): Provide a series of illustrations relating to of a single handle, suitable for use on a birth support in accordance with the present invention. For the avoidance of doubt a pair of such handles may be utilized, as illustrated in FIGS. 5 to 7, or a single large handle may be utilized which is arranged either around the rear of the uppermost chamber or layer, or around the top rear edge of the uppermost chamber of a birth support in accordance with the present invention;

FIG. 8(a): Illustrates a top-side view of a single handle (4) having a central raised portion 4(a) and a pair of corresponding tab portions 4(b);

FIG. 8(b): Illustrates a top view of the single handle (4) having a central grip section 4(c), and two raised portions 4(d) wherein the top-width of the handle taper outwards from each end of said central grip section to the corresponding tab portions 4(b);

FIG. 8(c): Illustrates a side view of the single handle (4) having a central grip section 4(c), and two raised portions 4(d) wherein the sectional width of the handle tapers downwards from each end of said central grip section to the corresponding tab portions 4(b);

FIG. 8(d): Illustrates an underside view of a single tab portion 4(b) and shows closure section 4(e) in use two of these closure sections are welded to the handle at each end, under the tab-portion, and then the two tab-portions are welded to the birth support to provide a single handle;

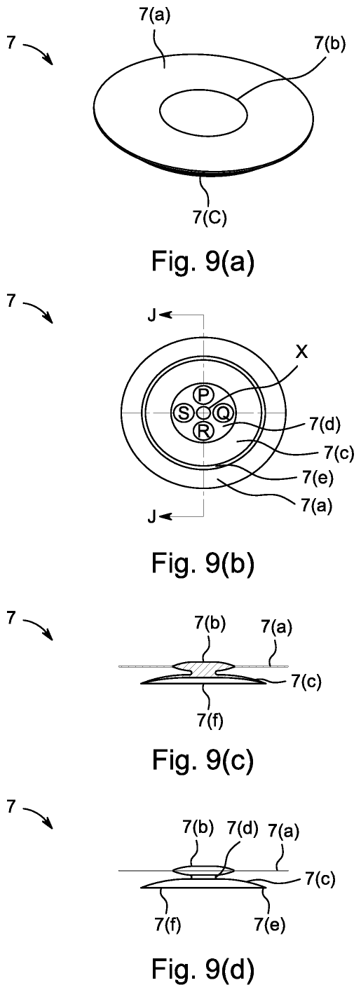

FIGS. 9(a), 9(b) and 9(c): Provide a series of illustrations relating to a single suction cup, for use on a birth support in accordance with the present invention. For the avoidance of doubt a number of such cups may be utilized, as illustrated in FIGS. 5 and 6, or either the underside of base layer or on the outermost edge of the base layer of a birth support in accordance with the present invention in order to provide stability and fixation;

FIG. 9(a): Illustrates a top view of a single weldable cup arrangement (7) having an outermost portion comprising a weldable disc 7(a) which is moulded as a single component to a suction cup. FIG. 9(a) also illustrates an uppermost portion of a suction cup of which the upper or top portion 7(b) and base portion 7(c) (just seen) are indicated;

FIG. 9(b): Illustrates an underside figurative view of a single weldable cup arrangement (7) having a central section 7(d) comprising a central hole X, and one or more additional holes for air trespass, and in this case, four additional equi-spaced holes P, Q, R, S, and having a surrounding outer lip portion 7(c) which is terminated by circumferential external rim 7(e). Feature 7(a) represents outer weldable disc and the relative position of this feature in relation to the suction cup is clearly illustrated in FIGS. 9(c) and 9(d).

FIG. 9(c): Illustrates a sectional view of the cup arrangement of FIG. 9(b) cut through section J to J. n underside figurative view of a single cup (7) having a central section 7(d) comprising a central hole X, and one or more additional holes for air trespass, and in this case, four additional equi-spaced holes P, Q, R, S, and having a surrounding outer lip portion 7(c) which is terminated by circumferential external rim 7(e). Feature 7(a) represents outer weldable disc and the relative position of this feature in relation to the suction cup is clearly illustrated in FIGS. 9(c) and 9(d).

FIG. 9(d): Illustrates a side-view of a single weldable cup arrangement (7) having an outer weldable disc 7(a) moulded to a suction cup which may be cast or moulded from a suitable flexible material, wherein said suction cup comprises an upper, or top portion 7(b), a lower lip section 7(c), a central section 7(d) and a rim section 7(e) the circumference of which surrounds and is connected/welded to a further section 7(f).

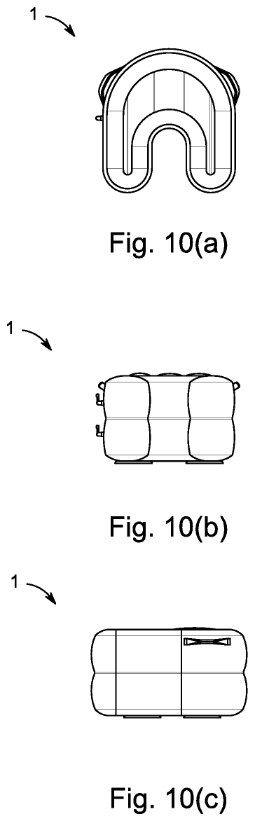

FIG. 10: Provides a series of illustrations relating to front, top and side-figurative views of the substantially U-shaped birth support (1) of FIG. 5;

FIG. 10(a): Illustrates a top-view of the substantially U-shaped birth support (1) of FIG. 5;

FIG. 10(b): Illustrates a front-facing view of the substantially U-shaped birth support (1) of FIG. 5; and FIG. 10(c): Illustrates a side-view of the substantially U-shaped birth support (1) of FIG. 5.

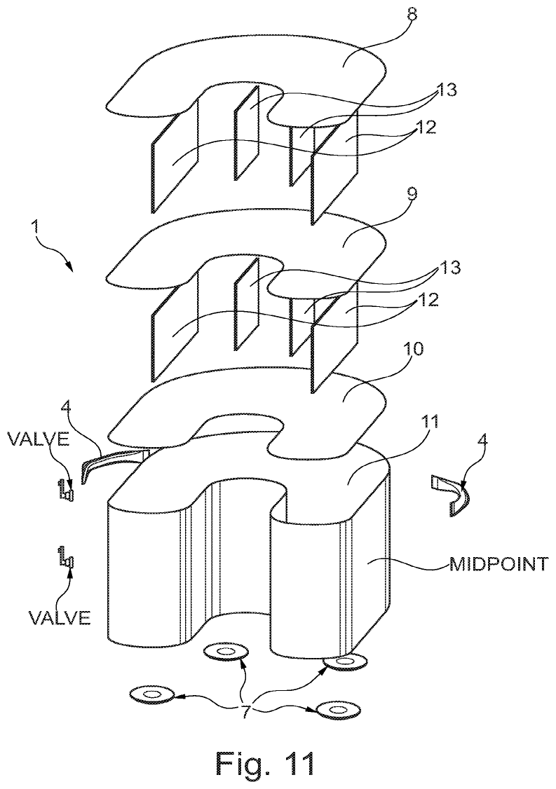

FIG. 11: Illustrates an expanded-view of a particular birth support having internal ribs for the provision of in-use birth support integrity and also indicates how a particular birth support may be constructed from a series of flexible panels, short and long ribs and an external wrapper. In particular, FIG. 11 shows how a birth support can be made via welding the external edges or seams of a series of cross panels of flexible material comprising: a top cross panel (8); one or more internal panels (9); and a base panel (10) onto a flexible external wrapper (11), and wherein a series of ribs aligned in parallel with each other are welded to the underside of the top panel and the one or more internal panels, and wherein the ribs comprise: a pair of long ribs (12) each one of which extends into one of the terminal sections of each layer; and a pair of corresponding short ribs (13) each one of which extends from the a point towards the rear of the seat portion of the birth support to a point towards the front portion of the birth support. To construct the birth support the downward extending ribs from the top (or seat-like) panel are welded to the top-face of an internal panel, and this process repeated until the downward extending ribs of the final internal panel are welded to the top-face of the base panel of the birth support, and the handles (4) and suction cups (7) are welded onto the external edge of the upper and the underside of the base layer.

According to a particular aspect, and as illustrated in FIG. 11, a single top cross panel, a single internal cross panel and a single base cross panel are utilized with ribs and a wrapper for such construction and wherein the internal cross panel is welded to the wrapper a height of about the midpoint of the external wrapper.

According to a further aspect, as illustrated in FIG. 11, the location of the ribs in each layer are substantially in alignment with one another.

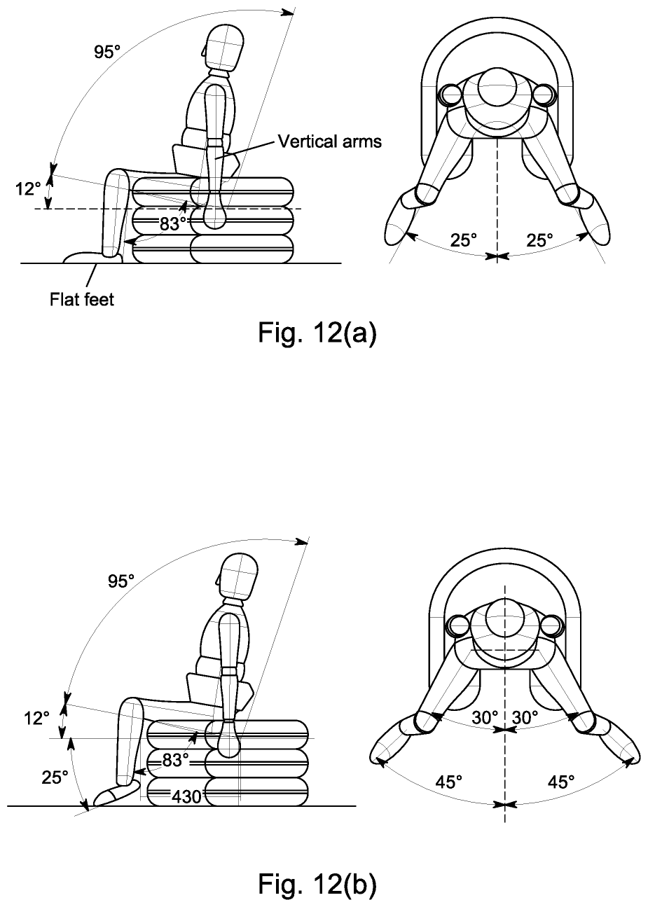

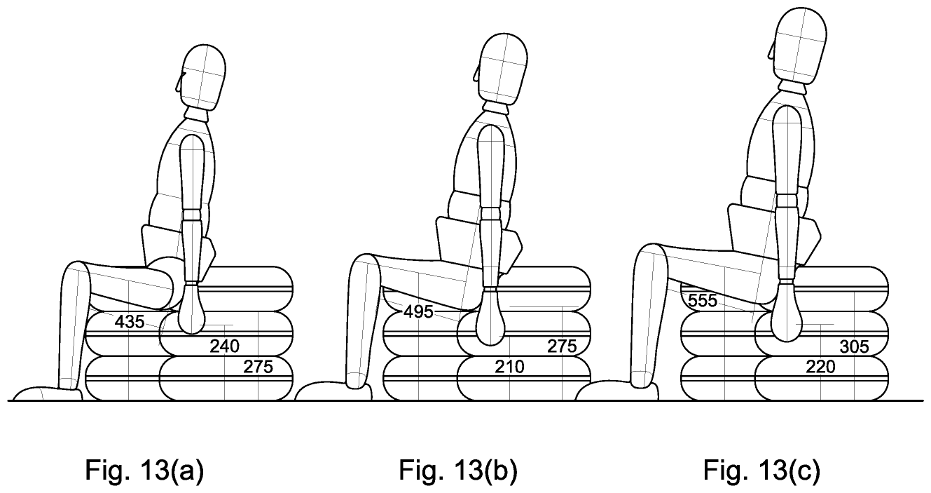

FIGS. 12(a) and 12(b): Illustrates use of an alternative embodiment of a birth support (14) herein having three inflatable compartments by a model in two different ergonomically suitable postures for labor. The Applicant has recognised that to provide optimal support the FIGS. 13(a), 13(b) and 13(c): Illustrate the suitability of use of the alternative birth support (14) of FIG. 12, by a range of mothers-to-be of different heights. As is clear from these three figures, all three mothers-to-be can use the birth support to achieve an optimal position for birth, and all three will also be likely to hold onto, grip or otherwise use the sides of the birth support for additional support within a similar and relatively short area.

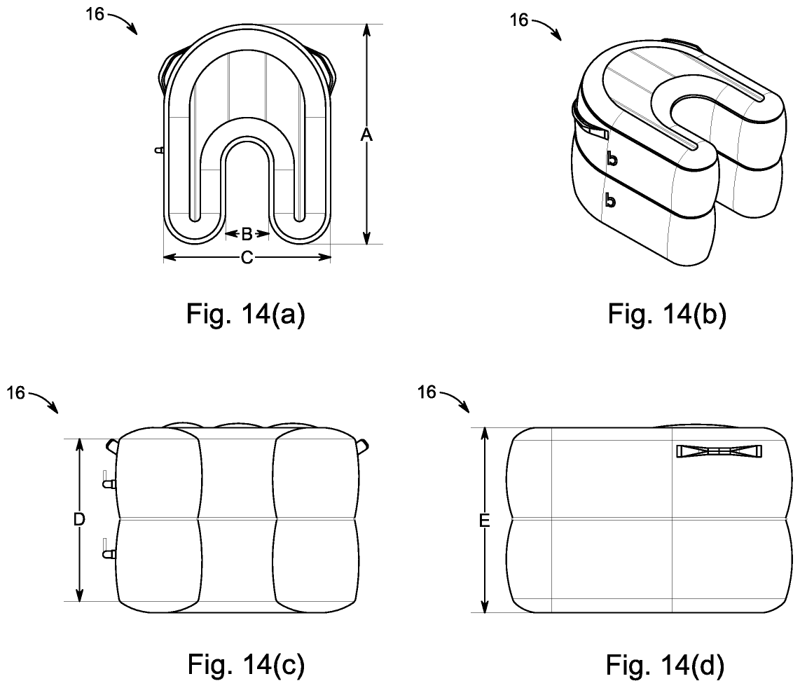

FIGS. 14(a), 14(b), 14(c), and 14(d): Illustrates an exemplary birth support (16) in accordance with the present invention. The birth support (16) has two inflatable chambers, a base chamber and an upper chamber, and a pair of handles located to the rear of U-shape one on each side of the upper chamber. Each chamber also has a separate inflation/deflation valve, the pair being represented by feature D. Whilst the valves are shown as being on one side of the U-shape, in a preferred embodiment the pair of valves are located at the rear of the U-shape, one on each chamber. The total depth of the birth support is indicated by the distance A, the total width of the birth seat is indicated by the distance C and the internal width of the widest point of the shallow U is indicated by the distance B.

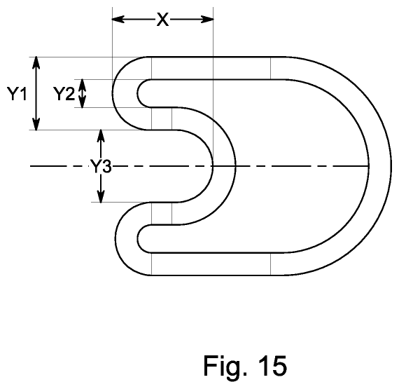

FIG. 15: Illustrated an alternative embodiment of a U-shaped birth support (17) in accordance with the invention.

Results

Exemplary Birth Supports

The Applicant has made and tested various arrangements of the birth support in accordance with the present invention.

An exemplary inflated birth support, in line with support (16) as illustrated in FIGS. 14(a), (b), (c) and (d) has two inflatable chambers, a base chamber and an upper chamber, and at least one handle, and ideally a pair of handles located to the rear of U-shape, one on each side of the upper chamber. In the exemplary birth support each chamber also has a separate inflation/deflation valve. The pair of inflation valves being preferably located at the rear of the outside of the U on either chamber, although as detailed hereinbefore alternative valve positions can be used without impact upon the suitability for use, stability or safety of the support. In this exemplary embodiment the total depth of the birth support, as indicated by distance A in FIG. 14(a), from the rear of the U-shape to the terminal ends of the U-shape is about 700 cm, the total width of the birth support between the external sides of the terminal ends of the U-shape, as indicated by the distance C in FIG. 14(a) is about 600 cm, and the internal width of the widest point of the shallow U, which is the space bounded by the interior of the shallow U, and as indicated by the distance B in FIG. 14(a) is about 130 cm, and the height of the birth support which is the distance from the surface to the top of the inflated upper chamber of the birth support, and as indicated by the distance E in FIG. 14(d) is about 400 cm.

Thus according to a further aspect the present invention provides a birth support in accordance with any of the embodiments detailed hereinbefore wherein the ratio of the total depth:the total width:the total height of the inflated birth support. is in the range of from about 2:1.5:1 to about 1.5:1.5:1, and preferably about 1.75:1.5:1.

According to a yet further aspect the present invention provides a birth support in accordance with any of the embodiments detailed hereinbefore wherein hereinbefore wherein the ratio of the total depth:the total width:the total height of the inflated birth support. is in the range of from about 2:1.5:1 to about 1.5:1.5:1, and preferably about 1.75:1.5:1, and wherein the height of the birth seat is from about 350 cm to about 450 cm, from about 375 cm to about 425 cm, or about 400 cm.

According to a further aspect the present invention provides a birth support in accordance with any of the embodiments detailed hereinbefore wherein the ratio of the total depth:the total width:the total height of the inflated birth support. is in the range of from about 2:1.5:1 to about 1.5:1.5:1, and preferably about 1.75:1.5:1, and the ratio of the total width of the inflated birth support to the internal width of the shallow U is in the range of from about 5.5:1 to about 4:1, from about 5:1 to about 4.5:1, about 4.6:1.

According to a further aspect the present invention provides a birth support in accordance with any of the embodiments detailed hereinbefore wherein the ratio of the total depth:the total width:the total height of the inflated birth support. is in the range of from about 2:1.5:1 to about 1.5:1.5:1, and preferably about 1.75:1.5:1, and the ratio of the total width of the inflated birth support to the internal width of the shallow U is in the range of from about 5.5:1 to about 4:1, from about 5:1 to about 4.5:1, about 4.6:1.

According to a further aspect the present invention provides a birth support in accordance with any of the embodiments detailed hereinbefore wherein the ratio of the total depth:the total width:the total height of the inflated birth support. is in the range of from about 2:1.5:1 to about 1.5:1.5:1, and preferably about 1.75:1.5:1, and the ratio of the total width of the inflated birth support to the internal width of the shallow U is in the range of from about 5.5:1 to about 4:1, from about 5:1 to about 4.5:1, about 4.6:1 and wherein the total width of the birth support is from about 550 to about 800 cm, from about 550 to about 700 cm, about 600 cm.

According to a yet further aspect the present invention provides a birth support in accordance with any of the embodiments detailed hereinbefore wherein hereinbefore wherein the ratio of the total depth:the total width:the total height of the birth support. is in the range of from about 2:1.5:1 to about 1.5:1.5:1, and preferably about 1.75:1.5:1, and wherein the height of the birth seat is from about 350 cm to about 450 cm, from about 375 cm to about 425 cm, or about 400 cm and the total width of the birth support is from about 550 to about 800 cm, from about 550 to about 700 cm, about 600 cm.

According to a yet further aspect the present invention provides a birth support in accordance with any of the embodiments detailed hereinbefore wherein hereinbefore wherein the ratio of the total depth:the total width:the total height of the birth support. is in the range of from about 2:1.5:1 to about 1.5:1.5:1, and preferably about 1.75:1.5:1, and wherein the height of the birth seat is from about 350 cm to about 450 cm, from about 375 cm to about 425 cm, or about 400 cm and the total width of the birth support is from about 550 to about 800 cm, from about 550 to about 700 cm, about 600 cm.

According to a further aspect the dimensions of the base, upper and internal patterns, and the dimensions and height of the external wrapper for construction of a birth support are adapted to provide an un-inflated, portable birth support, which once inflated provides a ratio of the total depth:the total width:the total height of the birth support. in the range of from about 2:1.5:1 to about 1.5:1.5:1, and preferably about 1.75:1.5:1, wherein the ratio of the depth of the shallow U to the total depth of the birth support, is from about 1:2.5 to about 1:3, and wherein the height of the birth seat is from about 350 cm to about 450 cm, from about 375 cm to about 425 cm, or about 400 cm and the total width of the birth support is from about 550 to about 800 cm, from about 550 to about 700 cm, about 600 cm.

According to a further aspect the dimensions of the base, upper and internal patterns, and the dimensions and height of the external wrapper for construction of a birth support are adapted to provide an un-inflated, portable birth support, which once inflated provides a ratio of the total depth:the total width:the total height of the birth support. in the range of from about 2:1.5:1 to about 1.5:1.5:1, and preferably about 1.75:1.5:1, and wherein the ratio of the depth of the shallow U to the total depth of the birth support, is from about 1:2.5 to about 1:3, wherein the height of the birth seat once inflated (the wrapper height) is from about 350 cm to about 450 cm, from about 375 cm to about 425 cm, or about 400 cm and wherein the total width of the birth support is from about 550 to about 800 cm, from about 550 to about 700 cm, about 600 cm.

FIG. 15 illustrates a further embodiment of a birth support in accordance with the invention wherein the ratio of the depth of the shallow U to the total depth of the birth support, is from about 1:2.5 to about 1:3 and wherein the ratio of the total width of the birth support to the internal width of the shallow U is about 2:1.

Safety Test Methodology and Results

The strength and durability of a birth support model in accordance with the invention has been tested. In particular the impact of weight being applied to different sections of the birth support on the internal pressure within the birth support. The strength and durability was tested with weight loads of up to 200 Kg. The purpose of this testing was to demonstrate the suitability of the birth support for use by mothers-to-be in a variety of different positions (i.e. putting different levels of pressure onto different areas of the birth support). This was achieved by assessment of changes to the internal pressure of a birth support when a known weight is applied centrally and also when that weight is then applied to alternative areas of the birth support.

The birth support used for these tests was the support illustrated in FIG. 14, and 10 replications of the tests were carried out to ensure reproducibility of the results. A compressor was used to inflate the birth supports. Any commercially available air compressor which can be carefully adjusted to enable gentle or robust inflation levels according to the desire of the tester may be suitably used. A pressure gauge was used to monitor the internal pressure. Any commercially available pressure gauge which is compatible with the internal pressure levels generated within the birth supports during these tests may be suitably used, such as for example a Comark Pressure Gauge, C9555 having a range of from 0 to 100 psi. The precise measurement of the weight loads used was measured using calibrated scales. Any commercially available calibrated scales capable of accurate measurements of weights between 100 and 200 kg may be suitably used.

Pressure Testing of Inflatable Birth Support

A three-way valve with tubing coming off each section was set-up with the open end of the first tube then being attached to the valve inflation adapter going into a first compartment of the birth support, the open end of the second tube then being attached to a pressure gauge, and the open end of the third and final tube being attached to an air compressor.

To test the impact of pressure on the birth support, the compressor was switched on and a first (upper) compartment of the birth support was carefully inflated with the pressure being monitored. This filling and pressure monitoring using the compressor and three-way valve was continued until this first (upper) compartment of the support is inflated and the partially-inflated birth support sample was firm to the touch but with a degree of flexibility.

As will be appreciated, for suitability of use during the birthing process the birth support is desirably not only safe, durable, and stable but also comfortable for the user, and as such a degree of flexibility is useful. As it is anticipated that a dual-compartment birth support will in the majority of cases be used with both compartments being inflated, these tests were designed to test the durability and safety of both compartments when faced with different weight loadings.

At this intermediate stage the internal pressure was recorded. The valve adaptor was then removed from the first compartment of the birth support and this first inflation valve was sealed with a plug. The remaining (second) compartment of the birth support was then inflated with pressure monitoring, until the same internal pressure as recorded for the first compartment is reached. At this point the valve adaptor was then removed and the second inflation valve was sealed with a plug. Both sections should be inflated to the same internal pressure. A series of weight load tests was then carried out on the birth support.

To monitor the impact of weight on the internal pressure within the birth support the pressure gauge on the three-way valve is re-attached to the upper section of the birth support, with care being taken to ensure that the valve is locked off to prevent air leakage from the birth support. A series of weights placed upon boards were used in these tests and to ensure consistency between test results the weight of both the board and the weights were measured using calibrated scales.

Test Sequence

The balanced and tilted weight loading tests were firstly carried out to measure the impact of weight variation on the internal pressure of the upper compartment of the birth support, and then the same tests were carried out for the lower, bottom or base compartment of the birth support.

Test 1: Balanced Weight Loading

A board and weights (180 Kg) was placed onto the upper section of the birth support and then left to rest for five minutes with the resulting internal pressure then being recorded. In this test the weights were arranged so-as to provide as far as practicably possible a balanced weight distribution across the board, and thereby to the birth support underneath.

Test 2: Tilted Weight Loading

In a further weight test sequence the calibrated scales were used to measure the weight of the board and the weights to be used (100 Kg in total) and the exact weight was recorded. The board and weights were placed onto the upper section of the birth support. In this test more weight was placed on the right hand side (when viewed from the front-end/open-end of the U-shape). Ideally the weights should be distributed so as to create a tilt on the birth support of at least about 30°, wherein the degree of tilting is judged by visual inspection. Once tilted the board, weights and birth support were left to rest for 5 minutes with the resulting internal pressure then being recorded. This 300 tilt-test was then carried out where more weight is placed on the left hand side, where more weight was placed at the rear, and where more weight was placed at the front of the birth support. The internal pressure of the birth support being recorded following each 5 minute rest-period. To provide a meaningful data-set for durability and safety purposes the full-set of four different tilt tests was repeated a further nine times with the internal pressure being recorded after each individual tilt-test.

The balances and tilt-testing was repeated with the birth support upside down and the board and weights being applied to the bottom section of the birth support.

The results of these tests confirmed that birth supports as provided herein are durable and have desirable weight bearing performance in stress testing. Internal pressures in the range of from about 3.4 to about 5.3 were observed with average internal pressures in the region of about 4 being recorded. In particular these stress tests have confirmed that birth supports in accordance with the present invention can be safely used at internal pressures of up to an including 4 p.s.i.

Use as a Birth Support

The Applicant has extensive experience as a midwife and based on her practical knowledge gained from assisting mothers in giving birth in hospitals, specialist birthing units and at home she recognised that despite the fact that, with the exception of planned caesarean sections, women can all too often have an unnecessarily painful, lengthy and exhausting birthing experience partly because their mobility is restricted to laying on their backs on a bed. The Applicant developed the birth support according to the present invention to specifically address this unmet need of a product that could be used by the majority of mothers in any environment.

The Applicant carried out ergonomic research to confirm that the ergonomics of birth supports in accordance with the invention would provide the optimal, upright position for birth. FIGS. 12 and 13 as discussed hereinbefore are illustrations which demonstrate that birth supports herein are adapted to provide the desired levels of support. As such it is reasonable to propose that use of the present birth supports mothers-to-be and encourages optimal, upright positions for birth. The suitability of the birth support to meet the support needs of mothers-to-be has been investigated by the Applicant using a range of techniques from confidential focus groups with midwifery professionals as well as expectant mothers; as well as using a bespoke survey which has confirmed that the principles underpinning the present birth support provision of both an upright birthing position and mobility throughout labor and childbirth are highly important to both mothers-to-be and midwives.

Birth supports according to the invention are now used throughout the Western, 3^{rd} and developing world and have been demonstrated to provide a safe, stable, flexible birth support to mothers-to-be across a wide range of settings and circumstances.

The Applicant, in her capacity as a midwife, has personally witnessed the use of birth supports in accordance with the present invention being successfully used by mothers-to-be during the three stages of labor and birth. In at least one instance the use of the birth support has been considered to be the instrumental factor in avoiding the need for a ventous-assisted birth.

We claim:

1. A substantially U-shaped birth support comprising
a series of inter-related inflation chambers provided by a plurality of U-shaped layers,
wherein each layer of the plurality of U-shaped layers comprises a correspondingly substantially U-shaped curvilinear hollow chamber,
wherein each substantially U-shaped curvilinear hollow chamber may be independently inflated and/or deflated,
wherein the plurality of U-shaped layers are located one upon another,
wherein each of the plurality of U-shaped layers is connectedly attached to at least one further layer of the plurality of U-shaped layers,
wherein each inflation chamber of the series of inter-related inflation chambers comprises a flat base portion, a flat upper portion and side portions, and
wherein the side portions may be flat or curved.

2. The birth support of claim 1, having at least two of the plurality of U-shaped layers, wherein each layer of the plurality of U-shaped layers has a substantially U-shaped pattern in which a central portion of the U-shape is deeper in width than corresponding lengths of each terminal end of the U-shape.

3. The birth support of claim 1, having at least two layers of the plurality of U-shaped, wherein each layer of the plurality of U-shaped layers has a substantially U-shaped pattern having a ratio of depth of a central portion depth of the U-shaped layer relative to length of either terminal portion of the U-shaped layer is from 2:1 to 1.2:1.

4. The birth support of claim 1, having at least two layers of the plurality of U-shaped wherein each layer of the plurality of U-shaped layers has a substantially U-shaped pattern having a ratio of the depth of a central portion depth of the U-shaped layer relative to length of either terminal portion of the U-shaped layer is 4:3.

5. The birth support of claim 1, having a relative width ratio between internal end-to-end widths of the U-shaped layers and a center-to-entry point of the U-shaped layers of from 1:5 to 1:3.

6. The birth support of claim 1, wherein each layer of the plurality of U-shaped layers includes at least one valve suitable for inflation/deflation, and wherein the at least one valve is an integral valve.

7. The birth support of claim 1, wherein the substantially U-shaped birth support includes a base layer having an underside, and wherein the underside of the base layer incorporates stabilizing means.

8. The birth support of claim 1, wherein one of said plurality of U-shaped layers additionally comprises one or more integral handles.

9. The birth support of claim 1, wherein one of said plurality of U-shaped layers additionally comprises one or more integral handles.

10. The birth support of claim 9, wherein the one or more integral handles are located upon an uppermost layer of the substantially U-shaped birth support.

11. The birth support of claim 1, comprising two or more of the plurality of U-shaped layers and wherein one or more supportive ribs is present inside one or more of the two or more layers.

12. The birth support of claim 1, wherein the series of inter-related inflation chambers includes two inflation chambers, each of the two inflation chambers of the series of inter-related inflation chambers including four internal supportive ribs, and wherein each of the two inflation chambers of the series of inter-related inflation chambers has an inflation/deflation valve.

13. The birth support of claim 1, wherein the substantially U-shaped birth support includes a base layer, and wherein the base layer comprises a hollow chamber having at least one valve suitable for gaseous inflation/deflation, and at least one valve suitable for liquid filling/emptying.

14. The birth support of claim 1, wherein the series of inter-related inflation chambers includes two or more inflation chambers, each of the two or more inflation chambers of the series of inter-related inflation chambers having one or more supportive internal ribs, and wherein the ratio of total depth:total width:total height of the inflated substantially U-shaped birth support is in the range of from 2:1.5:1 to 1.5:1.5:1.

15. A method for manufacturing a birth support the birth support comprising a series of inter-related inflation chambers provided by a plurality of U-shaped layers,
wherein each layer of the plurality of U-shaped layers comprises a correspondingly substantially U-shaped curvilinear hollow chamber,
wherein each substantially U-shaped curvilinear hollow chamber may be independently inflated and/or deflated,
wherein said plurality of U-shaped layers are located one upon another,
wherein each of the plurality of U-shaped layers is connectedly attached to at least one further layer of said plurality of U-shaped layers,
wherein each inflation chamber of the series of inter-related inflation chambers comprises a flat base portion, a flat upper portion and side portions, and
wherein said side portions may be flat or curved,
the method comprising the steps of:
(i) welding a first series of ribs aligned in parallel with each other to an underside of a U-shaped top panel;
(ii) welding the first series of ribs from (i) to a top-side of an internal U-shaped panel;
(iii) welding a second series of ribs aligned in parallel with each other to the underside of the internal U-shaped panel of (ii);
(iv) welding the second series of ribs from (iii) to the top-side of a U-shaped base panel;
(v) welding together the external edges or seams of the series of U-shaped panels of flexible material comprising: a U-shaped top panel; a U-shaped internal panel; and a U-shaped base panel onto an external flexible wrapper,
wherein the ribs comprise: a pair of long ribs each one of which extends into one of the terminal sections of each U-shaped layer; and a pair of corresponding short ribs each one of which extends from the a point towards the rear of the U-shaped portion of the substantially U-shaped birth support to a point towards the front portion of the substantially U-shaped birth support.
